(19) United States
(12) Patent Application Publication
(10) Pub. No.: US 2020/0343680 A1
(43) Pub. Date: Oct. 29, 2020

(54) WAVELENGTH SWITCHABLE LASER

(71) Applicant: Microsoft Technology Licensing, LLC, Redmond, WA (US)

(72) Inventors: Sophie Gloria LANGE, Cambridge (GB); Daniel Jonathan Finchley CLETHEROE, Cambridge (GB); Benn Charles THOMSEN, London (GB); Hitesh BALLANI, Cambridge (GB); Kai SHI, Cambridge (GB); Krzysztof JOZWIK, Cambridge (GB); Foteini KARINOU, Cambridge (GB); Raphael Eric Alfred BEHRENDT, Cambridge (GB); Istvan HALLER, Cambridge (GB); Hugh WILLIAMS, Cambridge (GB); Paolo COSTA, Cambridge (GB)

(21) Appl. No.: 16/450,093

(22) Filed: Jun. 24, 2019

(30) Foreign Application Priority Data
Apr. 24, 2019 (GB) 1905725.6

(51) Int. Cl. H01S 3/08; H01S 3/107

(52) U.S. Cl. CPC H01S 3/0809; H01S 3/107

(57) ABSTRACT

A wavelength switchable laser is described which has a multi-wavelength laser source configured to generate signals at different wavelengths. The wavelength switchable laser has a wavelength selector with a plurality of electro-optical switches, each electro-optical switch being configurable to transmit or block output of one of the signals from the multi-wavelength source according to the wavelength of the signal.

### CROSS-REFERENCE TO RELATED APPLICATION

This non-provisional utility application claims priority to UK patent application number 1905725.6 entitled “ WAVELENGTH SWITCHABLE LASER” and filed on Apr. 24, 2019, which is incorporated herein in its entirety by reference.

### BACKGROUND

In current data centers, electrical switches have been able to cope with the increasing internet traffic by doubling their bandwidth every two years, while keeping the same cost. While the free scaling of electrical switches is expected to come to an end soon, the network traffic is expected to grow dramatically with the increased use of cloud applications and digital media in the next years.

Optical switches are a promising solution to overcome the bandwidth limitations of electrical switches and have the additional advantage of improving the network latency caused by electro-optical conversion and buffering at each electrical switching stage. To implement an optical switch, a wavelength switchable laser is typically used. A wavelength switchable laser is a source which emits light of one of a plurality of specified wavelengths according to how it is configured or “switched” at a particular time.

The embodiments described below are not limited to implementations which solve any or all of the disadvantages of known wavelength switchable lasers.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

A wavelength switchable laser is described which has a multi-wavelength laser source configured to generate signals at different wavelengths. The wavelength switchable laser has a wavelength selector with a plurality of electro-optical switches, each of the electro-optical switches being configurable to transmit or block output of one of the signals from the multi-wavelength laser source according to the wavelength of the signal.

Many of the attendant features will be more readily appreciated as the same becomes better understood by reference to the following detailed description considered in connection with the accompanying drawings.

DESCRIPTION OF THE DRAWINGS

The present description will be better understood from the following detailed description read in light of the accompanying drawings, wherein:

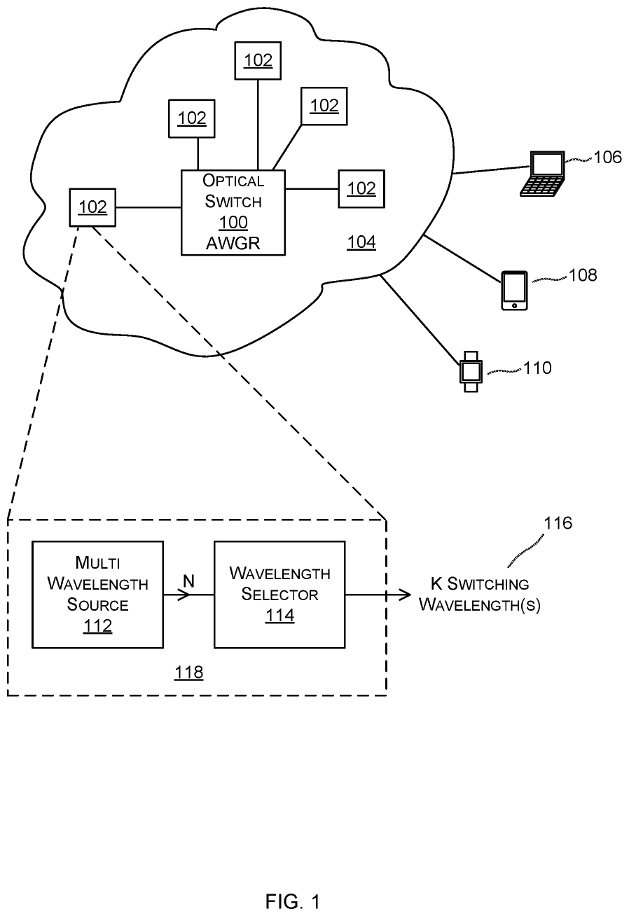

FIG. 1 is a schematic diagram of an optical switch in a data center and where the optical switch comprises an arrayed waveguide grating router (AWGR) and where each computation node comprises a wavelength switchable laser;

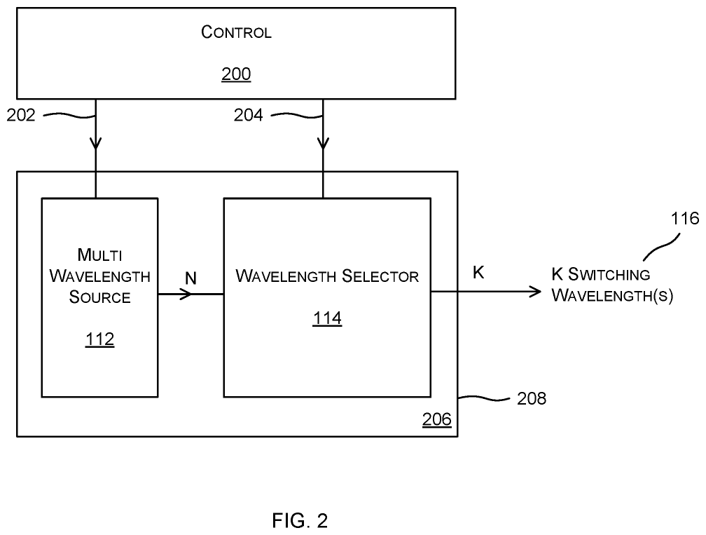

FIG. 2 is a schematic diagram of a wavelength switchable laser integrated on a chip and showing off-chip control circuitry;

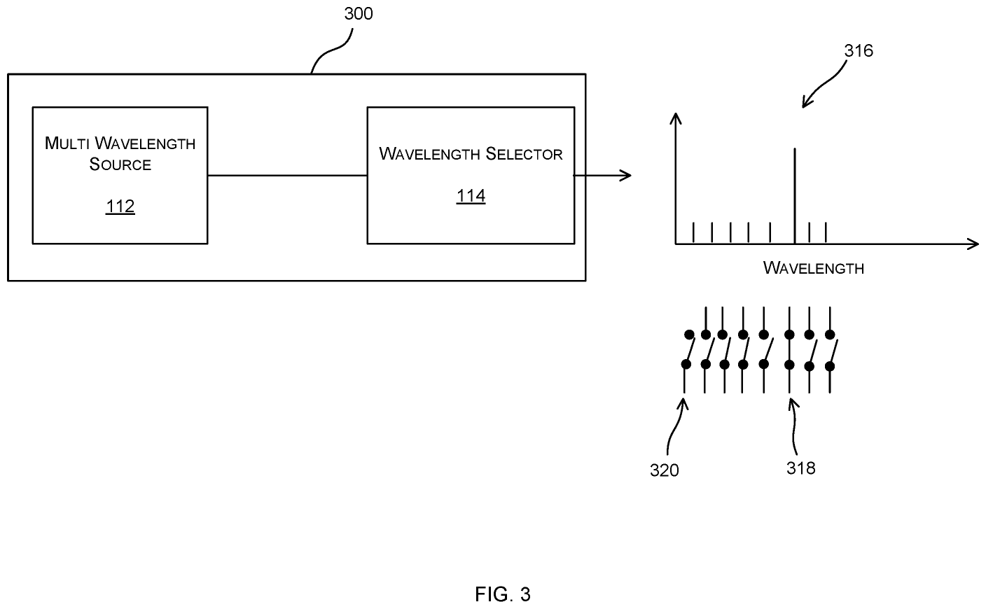

FIG. 3 is a schematic diagram of a wavelength switchable laser;

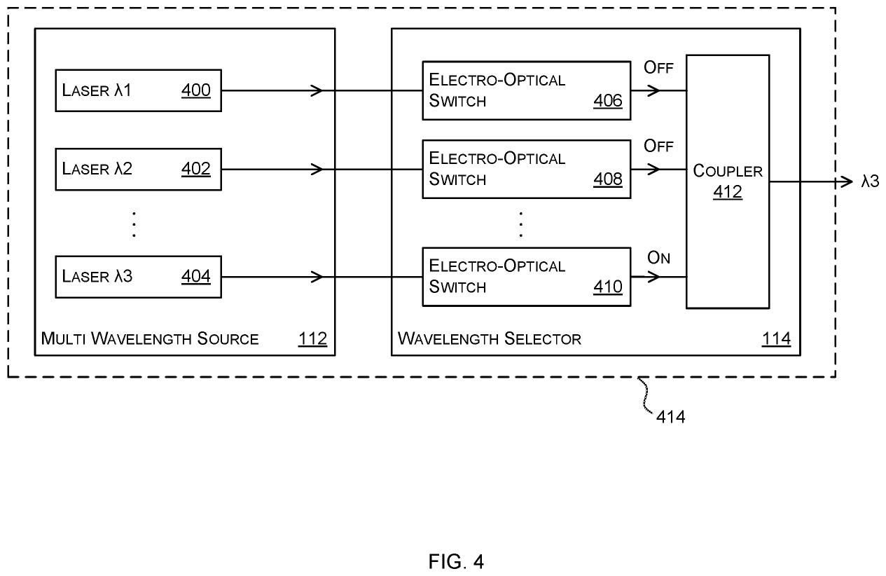

FIG. 4 is a schematic diagram of a wavelength switchable laser with a plurality of fixed wavelength lasers;

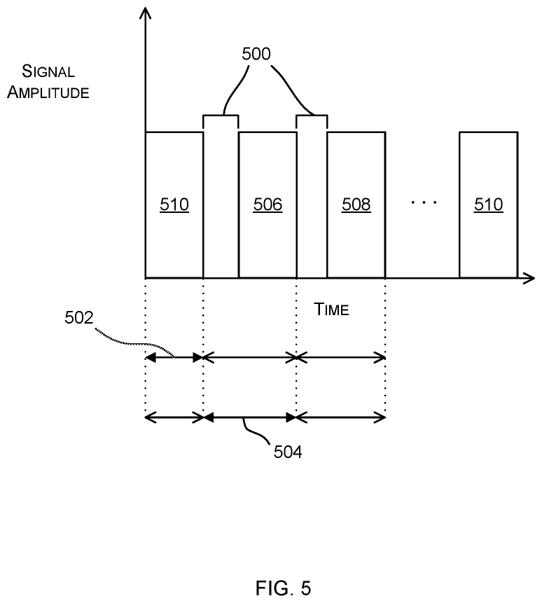

FIG. 5 is a schematic diagram of tuning time of a pair of tunable lasers and illustrating a guard band;

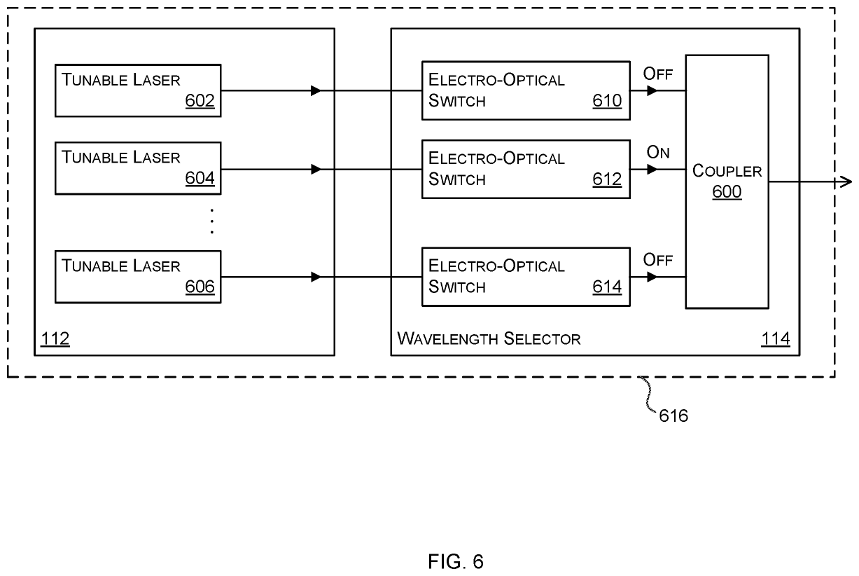

FIG. 6 is a schematic diagram of a wavelength switchable laser with a plurality of tunable lasers;

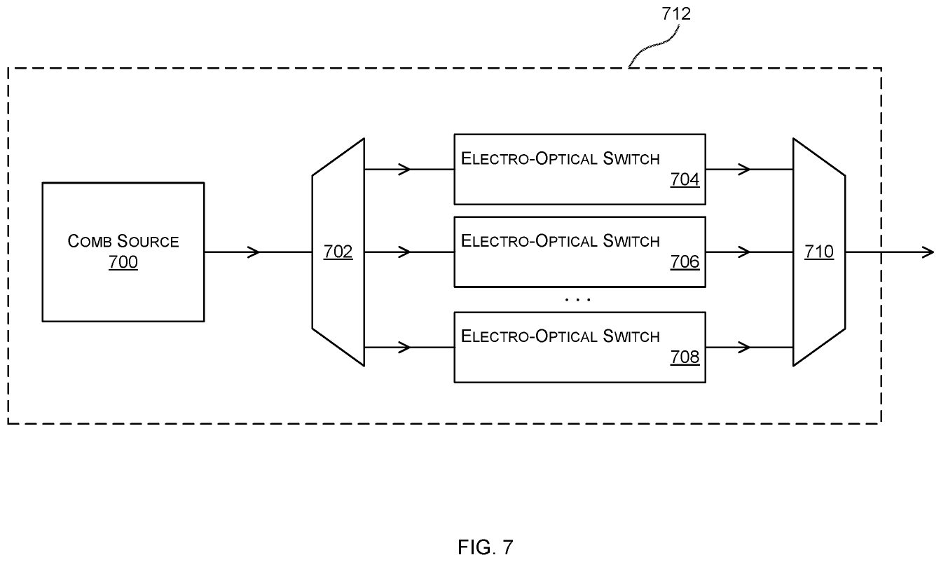

FIG. 7 is a schematic diagram of a wavelength switchable laser having a comb source, a wavelength sensitive splitter and a wavelength sensitive coupler;

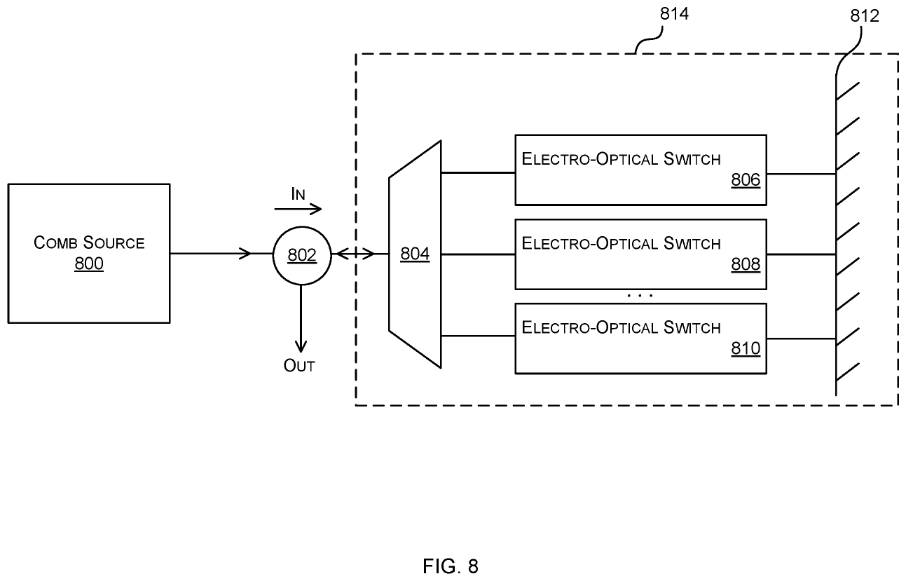

FIG. 8 is a schematic diagram of a wavelength switchable laser having a comb source and a circulator;

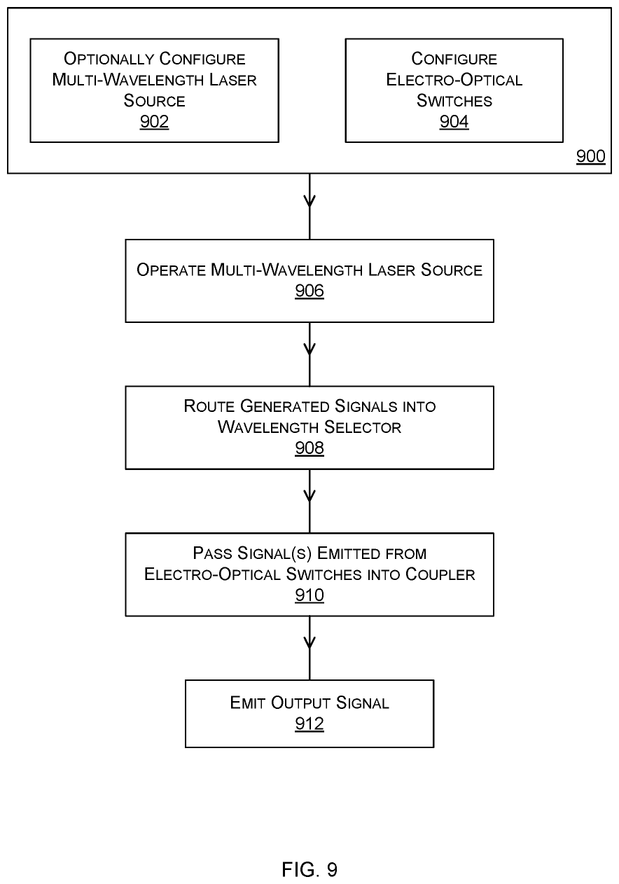

FIG. 9 is a flow diagram of a method performed by control circuitry and by a wavelength switchable laser.

Like reference numerals are used to designate like parts in the accompanying drawings.

### DETAILED DESCRIPTION

The detailed description provided below in connection with the appended drawings is intended as a description of the present examples and is not intended to represent the only forms in which the present example are constructed or utilized. The description sets forth the functions of the example and the sequence of operations for constructing and operating the example. However, the same or equivalent functions and sequences may be accomplished by different examples.

Optical networks are a promising solution to overcome the bandwidth limitations of electrical switches. In an example optical network a high radix optical switch routes individual packets of data to different destination nodes, on channels of different wavelength. Considering that in current data centers over 91% of the packets are smaller than 576 bytes, an optical switch reconfiguration time of a few nanoseconds is needed to reach more than 90% network utilization.

One way to implement an optical switch is to use a wavelength sensitive arrayed waveguide grating router in combination with a wavelength switchable laser formed from wavelength tunable lasers. But it is not straightforward to make a wavelength switchable laser which is able to switch wavelengths in only a few nanoseconds. If a wavelength switchable laser is created by using a thermally tuned laser, then the minimum wavelength switching time is in the tens of milliseconds range which is orders of magnitude longer than desired. If a wavelength switchable laser is created by using lasers tuned using electro-optic effects than the minimum wavelength switching time is around ten nanoseconds, which is at least an order of magnitude longer than desired.

The inventors have recognized that in conventional tunable lasers, the lasing and the selection of a wavelength is tightly coupled, and that as a consequence, it is challenging to achieve a nanosecond switching time for a broad range of wavelengths. In the present disclosure the generation of lasing signals at multiple wavelengths is separated from wavelength switching. As a result it is possible to reduce the time taken to switch between wavelengths emitted by a wavelength switchable laser effectively independently of the generation of the laser signals. In this way, wavelength switching times of around one nano-second or below are attainable.

FIG. 1 is a schematic diagram of part of a data center 104 comprising an optical communications network connecting a plurality of computation nodes 102. An optical switch 100 comprising an arrayed waveguide grating router (AWGR) is present in the optical communications network and acts to connect pairs of the computation nodes 102. Each computation node 102 has at least one wavelength switchable laser 118 as explained below. Connections are formed by the optical switch 100 in a time slotted manner, such that at each time slot, one pair of the computation nodes 102 is connected using a communications channel of a different wavelength. In each time slot a packet of data is transmitted between the pair of computation nodes 102 currently connected by the optical switch 100. When the time slots are in the order of tens of nanoseconds, the optical switch 100 operates at a high rate in the guard band between the time slots such as where the switching time is around one nano second or lower. The time slot (which includes the switching time and the data transmission time) will typically be 10 to 100 times longer than the switching time to amortize the reconfiguration time, since it is not possible to transmit data whilst switching.

The data center is accessible by one or more computing devices which send computations and or data to be processed in the data center and which receive results from the data center. The computing devices are any suitable computing devices such as laptop computer 106, smart phone 108, smart watch 110 or other computing device.

In order to switch at a high rate each node 102 comprises at least one wavelength switchable laser 118. In FIG. 1 one of the nodes 102 is shown in an exploded view to indicate more detail of the wavelength switchable laser 118. The wavelength switchable laser 118 has a multi wavelength source 112 which generates a plurality of laser signals at different wavelengths, and a wavelength selector 114. The wavelength selector 114 receives the plurality of signals (N signals each of a different wavelength) from the multi-wavelength source 112. It selects K switching wavelengths 116 from the N signals it receives, and outputs the K switching wavelengths 116. The number of switching wavelengths K is less than the number of signals N. In some cases K is one. The wavelength selector 114 blocks some of the signals it receives and allows one or more of the signals it receives to be output. The wavelength selector 114 is controllable independently of the multi-wavelength source 112. Since the wavelength selector 114 is controllable independently of the multi-wavelength source 112 it is not constrained by the “slow” nature of laser sources with regard to tuning and in this way fast switching times are achieved of around one nano-second or less.

Each node 102 of the communications network of FIG. 1 includes controller(s) for the multi wavelength source and wavelength selector, which can be implemented using one or more of a plethora of different, existing computing technologies, A non-exhaustive list of example computing technologies which are useable is system on chip (SoC), field programmable gate array (FPGA), application specific integrated circuit (ASIC).

The wavelength selectable laser operates in an unconventional manner whereby the wavelength selector is separate from the multi wavelength source such that in use the wavelength selector is optimizable independently of the multi-wavelength source.

By using a wavelength selector and a multi-wavelength source the functioning of the wavelength switchable laser is improved by enabling the wavelength selector to be optimized independently of the multi-wavelength source.

FIG. 2 shows a wavelength switchable laser 206 which is integrated on a single chip 208. The wavelength switchable laser 206 has a multi wavelength source 112 and a wavelength selector 114 as in FIG. 1. Off-chip is control circuitry 200. The control circuitry is connected to the multi wavelength source 112 via connection 202 and is connected to the wavelength selector via connection 204. The control circuitry sends control signals to control the multi wavelength source 112 independently of the control signals it sends to control the wavelength selector 114. In an example, the control signals sent to the wavelength selector are sent at a first rate which is higher than a second rate at which control signals are sent to the multi wavelength source.

FIG. 3 is a schematic diagram of a wavelength switchable laser 300 comprising a multi wavelength source 112 and a wavelength selector 114. The output of the wavelength switchable laser is a signal at one of a plurality of possible wavelengths. In FIG. 3 a graph of signal amplitude against wavelength shows a plurality of possible wavelengths that may be output by the wavelength switchable laser, only one of which is of a significant amplitude (see 316 in FIG. 3) in this example. The wavelength selector comprises a plurality of electro-optical switches shown schematically below the graph and where the switches are open except for one switch which is closed, with the closed switch being for signal amplitude 316.

The wavelength selector comprises a plurality of electro-optical switches controlled with electrical switching signals. In conventional tunable laser devices, the switching amplitude is directly related to the wavelength. In the technology described herein the wavelength is independent of the switching signal, so that the switching signal amplitude can be adjusted to make the switching time faster than of conventional tunable laser wavelength control signals.

FIG. 4 is an example where the multi wavelength source comprises a plurality of fixed wavelength lasers 400, 402, 404. In this example only three fixed wavelength lasers 400, 402, 404 are shown for clarity and the three dots between laser 402 and laser 404 indicates that additional fixed lasers are used in practice. Each fixed wavelength laser generates a laser signal at a fixed specified wavelength different from the other fixed wavelength lasers. In an example the fixed wavelength lasers 400, 402, 404 are distributed feedback lasers but it is not essential to use distributed feedback lasers and other types of lasers are used in some examples. For each fixed wavelength laser there is a corresponding electro-optical switch 406, 408, 410 in the wavelength selector 114. Each electro-optical switch is controlled independently to be either in an ON configuration or in an OFF configuration. In an OFF configuration the electro-optical switch blocks light emitted by the fixed wavelength laser that it is connected to. In an ON configuration the electro-optical switch transmits light it receives from the fixed wavelength laser that it is connected to, into a coupler 412 which couples the light into a single output waveguide. In the example of FIG. 4 electro-optical switch 410 is ON and transmits light of wavelength λ3 that it receives from laser 404, into coupler 412.

The coupler 412 is a wavelength sensitive arrayed waveguide grating coupler. Using this type of coupler avoids the intrinsic 3 dB coupling loss per 2 channels of a typical colorless coupler. The laser wavelengths and coupler wavelengths are matched so that the outputs of the electro-optical switches connect to the coupler 412 at positions where the wavelengths of the electro-optical switches match the wavelength of the coupler.

A non-exhaustive list of example electro-optical switches 406, 408, 410 which are used is: semiconductor optical amplifier, Mach-Zehnder interferometers, electro absorption modulators, micro-ring resonators.

In a preferred example, the electro-optical switches of FIG. 4 are semiconductor optical amplifiers. Using semiconductor optical amplifiers as the electro-optical switches of FIG. 4 is found to give a nanosecond switching time. That is, the wavelength switchable laser of FIG. 4, using semiconductor optical amplifiers as the electro-optical switches enables the output wavelength to be switched in around one nano-second or less. Using semiconductor optical amplifiers as the electro-optical switches of FIG. 4 is found to give broadband operation, small size and up to 60 decibel extinction ratio. Moreover, semiconductor optical amplifiers provide gain which compensates for insertion loss of the coupler 412. In the ON state of a semiconductor optical amplifier, a high voltage is applied to quickly increase the carrier density and gain. In the OFF state of a semiconductor optical amplifier a negative voltage quickly depletes signal carriers and attenuates the signal from the fixed laser source. Such a driving scheme facilitates reduced switching times.

The example of FIG. 4 is implemented using discrete components in some deployments. In this case, as the number of fixed wavelength sources increases the amount of space needed for the discrete components also increases.

In the example of FIG. 4 the wavelength switchable laser 414 is integrated on a single chip in some deployments in order to reduce the amount of space used. By integrating the wavelength switchable laser 414 on a single chip a compact device is obtained which is space-saving. In an example, the single chip is formed using photonic integration in some cases and this gives the benefit of reducing the amount of space used. When the lasers 400, 402, 404, electro-optical switches 406, 408, 410 and the coupler 412 are monolithically integrated on the same chip, the footprint of the wavelength switchable laser 414 is reduced to a millimeter scale.

An example photonic integrated circuit of the wavelength switchable laser 414 of FIG. 4 has been designed and fabricated in the indium phosphide platform. The example photonic integrated circuit has 16 fixed laser sources with different wavelengths in the C-band and has a 6 by 8 millimeter footprint. On each channel a distributed feedback laser and a semiconductor optical amplifier are integrated. The channels are combined with a wavelength sensitive arrayed waveguide grating coupler. With the fabricated wavelength switchable laser 414 sub nanosecond wavelength switching has been demonstrated. Note that this example is given to aid understanding of the technology and is not intended to limit the scope to indium phosphide platforms or other specific details of the example.

FIGS. 5 and 6 relate to an example where the multi wavelength source is formed from a plurality of tunable lasers. A tunable laser takes considerable time to tune as described above. Therefore, to reduce the time taken to switch wavelengths, one option is to use two or more tunable lasers in an alternating fashion. Whilst one tunable laser is in use, one or more other tunable lasers are getting ready.

Consider an example with two tunable lasers. FIG. 5 is a graph of signal amplitude against time of a signal output from the multi wavelength source. Each column of the graph represents a signal of a different wavelength, with the first column representing signal 510 amplitude from a first one of the tunable lasers at a first wavelength during time 502. A guard band 500 is a time during which there is no signal. Whilst tunable laser one is emitting a signal at a first wavelength during time 502, laser two is being tuned. Laser two emits a signal 506 after a guard band 500. In the meantime, laser one is being tuned during time 504 comprising a guard band 500 and the time during which laser two emits its signal 506. Laser one then emits signal 508 which is at a different wavelength from signal 510. Laser two is tuned during a guard band 500 and whilst laser one emits signal 508 and the process repeats.

Data center traffic typically consists of fixed length packets separated by a guard band. FIG. 5 illustrates the guard band 500 and illustrates signals 510, 506, 508 of fixed length each used to transmit a fixed length packet. During the guard band network reconfiguration steps occur such wavelength switching. Where the optical network is synchronized the guard band includes time for synchronization operations to occur. However, for good network utilization the guard band duration is to be reduced.

As shown in FIG. 5 multiple tunable lasers are used in an alternating fashion. When one laser lases at a desired wavelength during the first packet and guard band durations, other lasers have time to tune to subsequent wavelengths. An example tuning schedule for two tunable lasers is given in FIG. 5.

The resulting individual tuning time for each laser is given by: individual tuning time

=(number of tunable lasers−1)*(packet length+guard band)

The individual tuning time increases from the guard band to several packet and guard band lengths, depending on the number of lasers.

In some examples, a wavelength sequence to be generated by the wavelength switchable laser is chosen carefully, in order to reduce the tuning range of each tunable laser. The minimum tuning range for each laser is given as:

$$minimum laser tuning range = \frac{tuning range}{number of tunable lasers}$$

With a lower tuning range, tunable lasers with a lower complexity are used. The lasers are cyclically tuned in some examples, with one channel spacing step at a time, minimizing the tuning speed. To avoid crosstalk the wavelength selector blocks the tunable lasers while they are tuning. The wavelength selector switches between the tunable lasers using electro-optical switches as now explained with reference to FIG. 6.

FIG. 6 shows a wavelength switchable laser 616 where the multi wavelength source 112 comprises a plurality of tunable lasers 602, 604, 606. In FIG. 6 only three tunable lasers 602, 604, 606 are shown for clarity and the dots indicate that more tunable lasers are used in practice. It is possible to use two or more tunable lasers.

Each tunable laser has a corresponding electro-optical switch 610, 612, 614 in the wavelength selector. The electro-optical switches are of any suitable type as for FIG. 4 although in a preferred example semiconductor optical amplifiers are used. The multi wavelength source 112 and the wavelength selector 114 receive control signals as described with reference to FIG. 2. Suppose tunable laser 604 has been tuned and is lasing according to control signals received at the multi wavelength source 112. Outputs of the other tunable lasers are blocked by electro-optical switches 610 and 614 and tunable lasers 602 and 606 are tuned for future wavelengths of a sequence of wavelengths to be generated by the wavelength switchable laser 616. Electro-optical switch 612 is ON and transmits the signal from tunable laser 604 to coupler 600.

The wavelength selector comprises a colorless coupler 600 which couples the outputs of the electro-optical switches into a single output signal. Since the coupling loss is less severe for a low number of channels, a colorless coupler 600 is used. The colorless coupler eliminates the complexity of aligning the laser and the coupler wavelengths as in FIG. 4 and allows spare channels to be added to replace failed ones.

It is possible to modify the example of FIG. 6 by replacing the colorless coupler with a colored coupler and by aligning the laser and coupler wavelengths although in this case, changing the wavelength sequence to reduce the tuning range is not applicable since each channel of the coupler only lets through wavelengths at free spectral range spacing.

In the example of FIG. 6 the number of components is significantly reduced as compared with the example of FIG. 4 for the same range of wavelengths that the wavelength switchable laser switches between. As a result, the power consumption of the example of FIG. 6 is reduced as compared with that of FIG. 4.

The wavelength switchable laser 616 of FIG. 6 is monolithically integrated on a photonic integrated circuit in order to save space. However, it is also possible to deploy the wavelength switchable laser of FIG. 6 using individual components where space is available.

In the examples of FIGS. 7 and 8 the multi wavelength source is a comb laser. A comb laser is a single laser which generates many wavelength channels at the same time, for example, more than a hundred wavelength channels. Comb laser channels are coherent in contrast to the independent laser channels in the examples of FIGS. 4 and 6. Using coherent laser channels gives the benefit of a constant wavelength spacing between the channels over a wide range. The examples of FIGS. 7 and 8 give a fast wavelength switched laser which is scalable, since it switches between more than one hundred wavelength channels in a nanosecond timescale.

In the example of FIG. 7 the wavelength switchable laser 712 comprises a comb source 700 which is a comb laser, and a wavelength selector comprising a wavelength sensitive splitter 702 , a plurality of electro-optical switches 704, 706, 708 and a wavelength sensitive coupler 710 which couples outputs of the electro-optical switches 704, 706, 708 into a single output. Only three electro-optical switches 704, 706, 708 are shown although there are more in some examples as denoted by the three dots in FIG. 7. The light from the comb laser enters the wavelength sensitive splitter 702 and is split into a plurality of wavelengths. Each electro-optical switch operates for one of the wavelengths emitted by the splitter. The electro-optical switches are either ON or OFF as for the previous examples and are semiconductor optical amplifiers in a preferred example, although other types of electro-optical switch are used in some cases. The configuration of the electro-optical switches (which ones are ON and which ones are OFF) is controlled according to electrical control signals as described above at extremely fast rates. Electro-optical switches which are OFF block light from the wavelength sensitive splitter 702. Light of the desired wavelength passes through the electro-optical switch which is ON and is coupled by coupler 710 into the single output. The wavelength switchable laser 712 is deployed as a single chip or as an hybridly integrated device consisting of multiple chips in order to save space. Separate discrete components are used where space is not at issue.

In the example of FIG. 8 the wavelength switchable laser comprises a comb source 800 which is a comb laser, a circulator 802, and a wavelength selector 814 having a wavelength sensitive coupler 804, electro-optical switches 806, 808, 810 and a reflective facet 812. The comb source 800 lases light comprising many wavelengths, such as more than 100 wavelengths, and the circulator transmits the lased light from the comb source 800 into wavelength sensitive coupler 804 which acts as a wavelength sensitive splitter. The light is split into different wavelengths and forwarded to respective electro-optical switches 806, 808, 810, one electro-optical switch for each wavelength. If an electro-optical switch is in an ON state it transmits the light it receives onto the reflective facet 812 which reflects the light back into the electro-optical switch. The reflected light passes out of the electro-optical switch and into the wavelength sensitive coupler 804 which couples the light into a single output that enters the circulator 802. The circulator separates the reflected light from the light coming in from the comb source. The reflected light is transmitted out of the circulator as indicated in FIG. 8. If an electro-optical switch is in an OFF state it blocks the light it receives. By changing the configuration of the electro-optical switches between OFF and ON states it is possible to rapidly switch between wavelengths that exit the circulator.

In the example of FIG. 8 the wavelength selector 814 is optionally fabricated as a photonic integrated circuit. An indium phosphide-based wavelength selector photonic integrated circuit with 19 channels and a 6 by 8 millimeter footprint has been fabricated. With the fabricated wavelength selector 814, sub-nanosecond switching between wavelengths in the C-band is achieved.

FIG. 9 is a flow diagram of a method performed in part by control circuitry 200 and in part by any of the wavelength switchable lasers of the present technology. In parallel, the control circuitry 200 configures the electro-optical switches 904 and optionally configures the multi-wavelength laser source. In the example where the multi-wavelength laser source comprises a plurality of tunable lasers, then the control circuitry 200 has to configure to the multi wavelength laser source, since it instructs how and when to tune the lasers. In the examples using fixed wavelength lasers, and using comb lasers, the control circuitry does not need to dynamically control the multi wavelength source in a fast manner. By using parallelization at operation 900 efficiencies are achieved.

The multi-wavelength laser source operates 906 and lases light at a plurality of signals of different wavelengths. The generated signals are routed 908 into a wavelength selector which comprises a plurality of electro-optical switches that have been configured during operation 904. Any signals which are not blocked by the electro-optical switches are emitted 910 and passed into a coupler before being emitted 912 as an output signal.

Alternatively or in addition to the other examples described herein, examples include any combination of the following:

Clause A. A wavelength switchable laser comprising:
a multi-wavelength laser source configured to generate signals at different wavelengths; and
a wavelength selector having a plurality of electro-optical switches, each of the electro-optical switches being configurable to transmit or block output of one of the signals from the multi-wavelength laser source according to the wavelength of the signal. By having a multi-wavelength laser source and a wavelength selector it is possible tow reduce the time taken to switch wavelengths of the wavelength switchable laser.

Clause B The wavelength switchable laser of claim 1 comprising control circuitry for controlling the multi-wavelength laser source and the wavelength selector independently of one another. By controlling the wavelength selector independently of the multi-wavelength laser source it is possible to reduce the wavelength switching time without being constrained by time taken to configure the source.

Clause C The wavelength switchable laser of claim 2 wherein the control circuitry controls the multi-wavelength laser source at a slower rate than the wavelength selector. Since the multi-wavelength laser source is controlled at a slower rate it is possible to take account of time taken to control the laser source.

Clause D The wavelength switchable laser of claim 1 wherein the multi-wavelength laser source is configured to generate N signals, where N is two or more, and wherein the wavelength selector is configured to transmit K of the generated signals, where K is less than N, and to block N-K of the generated signals. By blocking some of the generated signals the wavelength selector is able to efficiently and effectively switch wavelengths of the wavelength switchable laser.

Clause E The wavelength switchable laser of claim 1 which is implemented on a single chip. In this way space is saved as compared with using separate components to implement the wavelength switchable laser.

Clause F The wavelength switchable laser of claim 1 wherein the wavelength selector comprises at least one wavelength sensitive coupler connected to the electro-optical switches to couple the outputs of the electro-optical switches into a single output. Using a wavelength sensitive coupler is an efficient way to combine the outputs of the electro-optical switches with fixed insertion loss independent of the number of channels.

Clause G The wavelength switchable laser of claim 1 wherein the multi-wavelength laser source comprises a plurality of fixed wavelength lasers. Using fixed wavelength lasers is a simple and effective way of implementing the wavelength switchable laser.

Clause H The wavelength switchable laser of claim 1 wherein the wavelength selector comprises a plurality of semiconductor optical amplifiers and a wavelength sensitive arrayed waveguide grating coupler, which couples the outputs of the semiconductor optical amplifiers. Semiconductor optical amplifiers are particularly effective since they give a nanosecond switching time, broadband operation, small size and up to 60 decibel extinction ratio. Moreover, semiconductor optical amplifiers give gain which compensates for coupler insertion loss.

Clause I The wavelength switchable laser of claim 1 wherein the fixed wavelength lasers are distributed feedback lasers as these are effective and compact.

Clause J The wavelength switchable laser of claim 1 wherein the multi-wavelength laser source comprises a plurality of tunable lasers. By using tunable lasers the range of wavelengths that the wavelength switchable laser switches between with a certain amount of lasers is increased.

Clause K The wavelength switchable laser of claim 10 comprising a color-less coupler coupling outputs of the electro-optical switches. Using a colorless coupler enables spare channels to be added to replace failed ones, and gives a simpler construction of the wavelength switchable laser.

Clause L The wavelength switchable laser of claim 10 comprising control circuitry, the control circuitry configured to operate one of the plurality of tunable lasers whilst one or more others of the tunable lasers are being tuned. By alternating in this way the time restrictions for the individual tuning time of each laser are accommodated.

Clause M The wavelength switchable laser of claim 11 wherein the wavelength selector is configured to block individual ones of the tunable lasers during tuning of the individual ones of the tunable lasers. Blocking in this way reduces crosstalk in the behavior of the wavelength switchable laser.

Clause N The wavelength switchable laser of claim 1 wherein the multi-wavelength laser is a comb laser. Using a comb laser is a compact and scalable solution which gives a large number of channels, such as more than one hundred channels.

Clause O The wavelength switchable laser of claim 14 wherein the wavelength selector comprises a wavelength sensitive splitter connected between the comb laser and the electro-optical switches.

Clause P The wavelength switchable laser of claim 15 wherein the wavelength selector comprises a wavelength sensitive coupler connected to outputs of the electro-optical switches.

Clause Q The wavelength switchable laser of claim 14 wherein the wavelength selector comprises a reflective facet at outputs of the electro-optical switches the reflective facet configured to reflect outputs of the electro-optical switches back through the electro-optical switches to a wavelength sensitive coupler connected to a circulator. The resulting arrangement reduces the required chip area making it compact and effective as well as scalable to a large number of channels. In addition, the wavelength offset between the two couplers in the arrangement of FIG. 7 (702, 710) due to the fabrication tolerance, is avoided.

Clause R The wavelength switchable laser of claim 17 wherein the wavelength-sensitive coupler also acts as a wavelength sensitive splitter to split a signal received from the comb source via the circulator.

Clause S A wavelength switchable laser comprising:
a multi-wavelength laser source configured to generate signals at different wavelengths;
a wavelength selector having a plurality of electro-optical switches, each electro-optical switch being configurable to transmit or block output of one of the signals from the multi-wavelength source according to the wavelength of the signal; and
control circuitry which controls configuration of the electro-optical switches at a first rate which is higher than a second rate at which the control circuitry controls the multi-wavelength laser source.

Clause T A method comprising:
operating a multi-wavelength laser source to generate signals at a plurality of wavelengths; and
routing the generated signals into a wavelength selector having a plurality of electro-optical switches;
configuring each electro-optical switch to transmit or block one of the signals from the multi-wavelength source according to the wavelength of the signal.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

The term ‘subset’ is used herein to refer to a proper subset such that a subset of a set does not comprise all the elements of the set (i.e. at least one of the elements of the set is missing from the subset).

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

1. A wavelength switchable laser comprising:
a multi-wavelength laser source configured to generate signals at different wavelengths; and
a wavelength selector having a plurality of electro-optical switches, each of the electro-optical switches being configurable to transmit or block output of one of the signals from the multi-wavelength laser source according to the wavelength of the signal.

2. The wavelength switchable laser of claim 1 comprising control circuitry for controlling the multi-wavelength laser source and the wavelength selector independently of one another.

3. The wavelength switchable laser of claim 2 wherein the control circuitry controls the multi-wavelength laser source at a slower rate than the wavelength selector.

4. The wavelength switchable laser of claim 1 wherein the multi-wavelength laser source is configured to generate N signals, where N is two or more, and wherein the wavelength selector is configured to transmit K of the generated signals, where K is less than N, and to block N-K of the generated signals.

5. The wavelength switchable laser of claim 1 which is implemented on a single chip.

6. The wavelength switchable laser of claim 1 wherein the wavelength selector comprises at least one wavelength sensitive coupler connected to the electro-optical switches to couple the outputs of the electro-optical switches into a single output .

7. The wavelength switchable laser of claim 1 wherein the multi-wavelength laser source comprises a plurality of fixed wavelength lasers.

8. The wavelength switchable laser of claim 1 wherein the wavelength selector comprises a plurality of semiconductor optical amplifiers and a wavelength sensitive arrayed waveguide grating coupler, which couples the outputs of the semiconductor optical amplifiers.

9. The wavelength switchable laser of claim 1 wherein the fixed wavelength lasers are distributed feedback lasers.

10. The wavelength switchable laser of claim 1 wherein the multi-wavelength laser source comprises a plurality of tunable lasers.

11. The wavelength switchable laser of claim 10 comprising a color-less coupler coupling outputs of the electro-optical switches.

12. The wavelength switchable laser of claim 11 wherein the wavelength selector is configured to block individual ones of the tunable lasers during tuning of the individual ones of the tunable lasers.

13. The wavelength switchable laser of claim 10 comprising control circuitry, the control circuitry configured to operate one of the plurality of tunable lasers whilst one or more others of the tunable lasers are being tuned.

14. The wavelength switchable laser of claim 1 wherein the multi-wavelength laser is a comb laser.

15. The wavelength switchable laser of claim 14 wherein the wavelength selector comprises a wavelength sensitive splitter connected between the comb laser and the electro-optical switches.

16. The wavelength switchable laser of claim 15 wherein the wavelength selector comprises a wavelength sensitive coupler connected to outputs of the electro-optical switches.

17. The wavelength switchable laser of claim 14 wherein the wavelength selector comprises a reflective facet at outputs of the electro-optical switches the reflective facet configured to reflect outputs of the electro-optical switches back through the electro-optical switches to a wavelength sensitive coupler connected to a circulator.

18. The wavelength switchable laser of claim 17 wherein the wavelength-sensitive coupler also acts as a wavelength sensitive splitter to split a signal received from the comb source via the circulator.

19. A wavelength switchable laser comprising:
a multi-wavelength laser source configured to generate signals at different wavelengths;
a wavelength selector having a plurality of electro-optical switches, each of the electro-optical switches being configurable to transmit or block output of one of the signals from the multi-wavelength source according to the wavelength of the signal; and
control circuitry which controls configuration of the plurality of the electro-optical switches at a first rate which is higher than a second rate at which the control circuitry controls the multi-wavelength laser source.

20. A method comprising:
operating a multi-wavelength laser source to generate signals at a plurality of wavelengths;
routing the generated signals into a wavelength selector having a plurality of electro-optical switches; and
configuring each of the plurality of electro-optical switches to transmit or block one of the signals from the multi-wavelength source according to the wavelength of the signal.
